(19) United States
(12) Patent Application Publication
(10) Pub. No.: US 2009/0051606 A1
(43) Pub. Date: Feb. 26, 2009

(54) ELECTRONIC CIRCUIT MODULE WITH BUILT-IN ANTENNA AND METHOD FOR MANUFACTURING THE SAME

(76) Inventors: Shozo Ochi, Osaka (JP); Hidenobu Nishikawa, Nara (JP); Hiroshi Sakurai, Osaka (JP)

Correspondence Address: MCDERMOTT WILL & EMERY LLP, 600 13TH STREET, NW, WASHINGTON, DC, 20005-3096, US

(21) Appl. No.: 12/296,509

(22) PCT Filed: Apr. 25, 2007
(86) PCT No.: PCT/JP2007/058928

§ 371 Date: Oct. 8, 2008

(30) Foreign Application Priority Data
Apr. 28, 2006 (JP) 2006-125500

(51) Int. Cl. H01Q 1/00; H01Q 1/22

(52) U.S. Cl. 343/702; 29/600; 343/787

(57) ABSTRACT

An electronic circuit module with a built-in antenna (1) includes the following elements: a mounting module having a wiring board (2), a passive component, and a semiconductor device; a resin sheet substrate (11) having an antenna pattern (12) formed on a first principle surface of a base thereof; and a magnetic layer interposed between the mounting module and the resin sheet substrate (11). These elements are housed in a case (16).

### TECHNICAL FIELD

The present invention relates to an electronic circuit module with a built-in antenna and a method for manufacturing the same in which an antenna function is built in a non-contact IC card, a LAN card for a wireless LAN or the like, a secure digital (SD) memory card used as a record media, or the like.

### BACKGROUND ART

In recent years, addition of a wireless communication function to a card-type record media with a built-in memory device or a CPU device has been requested to improve the application range and convenience of use of such a record media. Those developed as the above apparatus include a memory card having a wireless transmission and reception function, and a high-frequency semiconductor module having an antenna function.

Hereinafter, a description is provided of a conventional electronic circuit module with a built-in antenna. FIG. 6 is a diagram showing a first example of the conventional electronic circuit module with the built-in antenna. FIG. 6 is a development of an SD memory card. Memory device 31 and CPU device 32 are mounted on mounting module 30. On the other hand, antenna 35 is formed by printing a conductive material on adhesive part 34.

The thus structured mounting module 30 and antenna 35 are folded each other in the direction shown by the arrows in the drawing so that connection line 33 on the mounting module is aligned and in contact with antenna 35. Then, the mounting module and the antenna are bonded and fixed to each other by adhesive part 34 (see Patent Document 1, for example).

The thus structured electronic circuit module with the built-in antenna can read data from the equipment, and store the data in the module in a non-contact manner.

FIG. 7 is a sectional view showing a second example of the conventional electronic circuit module with the built-in antenna. FIG. 7 is a high-frequency semiconductor module for use in a wireless LAN or the like. This module includes base plate 41, antenna substrate 42 having antenna pattern 43 for transmission and reception, semiconductor devices 48 and 49, circuit board 46, and conductor lead 50.

On the base having a low dielectric constant of circuit board 46, wiring conductor 51 made of an Ni/Au-plated Cu foil is formed, as a conductor. Circuit board 46 and semiconductor devices 48 and 49 are bonded and fixed onto base plate 41 by an Ag paste agent. Further, a tape for tape automated bonding (TAB) having a conductor layer on one side thereof is precisely positioned on circuit board 46 and fixed thereto using a temporary-tacking adhesive. Using a bonding tool, the conductor lead on the TAB tape is ultrasonically bonded to the electrodes of semiconductor devices 48 and 49. Thereafter, the conductor lead on the TAB tape is ultrasonically bonded to wiring conductor 51 on circuit board 46. Then, the temporary-tacking adhesive and the TAB film are removed so that conductor lead 50 is left. At this time, wiring conductor 51 on circuit board 46 and antenna pattern 43 on antenna substrate 42 are coupled via center conductor 52 penetrating through base plate 41, or the like. This structure can reduce the signal transmission loss and improve the stability of the characteristics because conductor lead 50 has a larger cross section, so as to be a smaller wiring resistance than an Au wire (see Patent Document 2, for example).

However, for the first example, in the step of connecting the mounting module having semiconductor devices mounted thereon to the antenna, after the antenna is bonded to the adhesive part, the antenna need to be aligned with the connection line in the mounting module and bonded to the mounding module. At this time, the contact portion is not visible from the upward direction. This causes a problem in the connection method, including alignment.

The second example requires a complicated manufacturing step, including temporarily bonding the TAB tape, and removing the TAB film after bonding. This causes a problem in productivity.

Further, in both examples, no description is provided of the influence of the electromagnetic waves reflected from the semiconductor devices on the antenna characteristics and no disclosure is provided of the solutions thereof. Particularly for the SD card in which semiconductor devices occupy the most part of the case thereof, the influence of the reflected electromagnetic waves is serious, and the solutions thereof are also problems to be addressed.

### [Patent Document 1] Japanese Patent Unexamined Publication No. 2006-18624

### [Patent Document 2] Japanese Patent Unexamined Publication No. 2003-59968

### SUMMARY OF THE INVENTION

An electronic circuit module with a built-in antenna includes the following elements:

a mounting module that includes the following elements:
a wiring board that has a wiring pattern formed on a first principle surface thereof and connected to a passive component and a semiconductor device, and a plurality of penetrating electrodes connected to the wiring pattern; and
the passive component and the semiconductor device mounted on the wiring board;

a resin sheet substrate that has an antenna pattern formed on a first principle surface of a base thereof so that a first terminal of the antenna pattern projects in an opening provided through the base and a second terminal of the antenna pattern projects from one side of the outer periphery of the base; and

a magnetic layer interposed between a second principle surface of the wiring board of the mounting module and a second principle surface of the base of the resin sheet substrate.

The semiconductor device is electrically coupled to the first terminal and the second terminal of the resin sheet substrate via the penetrating electrodes of the mounting module. Further, the mounting module and the resin sheet substrate are housed in a case.

With this structure, the magnetic layer containing magnetic particles can prevent the influence of electromagnetic waves reflected in the mounting module. Thus, a stable, constant communication distance can be secured without any change in antenna sensitivity.

A method of manufacturing an electronic circuit module with a built-in antenna includes the following steps:

mounting a passive component and a semiconductor device on a wiring board that has a wiring pattern formed on a first principle surface thereof and to be connected to the passive component and the semiconductor device, and a plurality of penetrating electrodes connected to the wiring pattern, thereby forming a mounting module;

forming an antenna pattern on a first principle surface of a base of a resin sheet substrate so that a first terminal of the antenna pattern projects in an opening provided through the base and a second terminal of the antenna pattern projects from one side of the outer periphery of the base;

bonding a second principle surface of the base of the resin sheet substrate to a second principle surface of the wiring board via a magnetic layer, and coupling the first terminal and the second terminal of the antenna pattern to the penetrating electrodes of the mounting module; and

housing the mounting module and the resin sheet substrate in a case.

This method can provide successive manufacturing steps and considerably improve the productivity.

### BRIEF DESCRIPTION OF THE DRAWINGS

FIG. 1A is a drawing for explaining an electronic circuit module with a built-in antenna in accordance with an exemplary embodiment of the present invention.

FIG. 1B is a sectional view taken on line 1B-1B of FIG. 1A.

FIG. 2A is a sectional view for explaining a method of manufacturing the electronic circuit module with the built-in antenna in accordance with the exemplary embodiment of the present invention.

FIG. 2B is a sectional view for explaining the method of manufacturing the electronic circuit module with the built-in antenna in accordance with the exemplary embodiment of the present invention.

FIG. 2C is a sectional view for explaining the method of manufacturing the electronic circuit module with the built-in antenna in accordance with the exemplary embodiment of the present invention.

FIG. 2D is a sectional view for explaining the method of manufacturing the electronic circuit module with the built-in antenna in accordance with the exemplary embodiment of the present invention.

FIG. 3A is a drawing for explaining a first step of a method of manufacturing an antenna substrate in accordance with the exemplary embodiment of the present invention.

FIG. 3B is a sectional view taken on line 3B-3B of FIG. 3A.

FIG. 3C is a sectional view for explaining the first step of the method of manufacturing the antenna substrate in accordance with the exemplary embodiment of the present invention.

FIG. 4A is a drawing for explaining a second step of the method of manufacturing the antenna substrate in accordance with the exemplary embodiment of the present invention.

FIG. 4B is a sectional view taken on line 4B-4B of FIG. 4A.

FIG. 5A is a drawing for explaining a third step of the method of manufacturing the antenna substrate in accordance with the exemplary embodiment of the present invention.

FIG. 5B is a sectional view taken on line 5B-5B of FIG. 5A.

FIG. 6 is a drawing showing a first example of a conventional electronic circuit module with a built-in antenna.

FIG. 7 is a drawing showing a second example of the conventional electronic circuit module with the built-in antenna.

### REFERENCE MARKS IN THE DRAWINGS

1 Electronic circuit module with built-in antenna
2 Wiring board
2a, 11a First principle surface
2b, 11b Second principle surface
3 Wiring pattern
4 External connection terminal
5a, 5b Penetrating electrode
6, 8, 48, 49 Semiconductor device
7, 9 Electrode
10 Passive component
11 Resin sheet substrate
12, 43 Antenna pattern
12a Cu foil
13 Opening (first opening)
14 Magnetic layer
15a First terminal
15b Second terminal
16 Case
17, 30 Mounting module
19 Pressure
20 Integral structure
22 Carrier tape
23 Second opening
24 Cutting plane line
31 Memory device
32 CPU device
33 Connection line
34 Adhesive part
35 Antenna
41 Base plate
42 Antenna substrate
46 Circuit board
50 Conductor lead
51 Wiring conductor

### DETAILED DESCRIPTION OF PREFERRED EMBODIMENT

Hereinafter, a description is provided of an electronic circuit module with a built-in antenna in accordance with an exemplary embodiment of the present invention, with reference to the accompanying drawings.

### Exemplary Embodiment

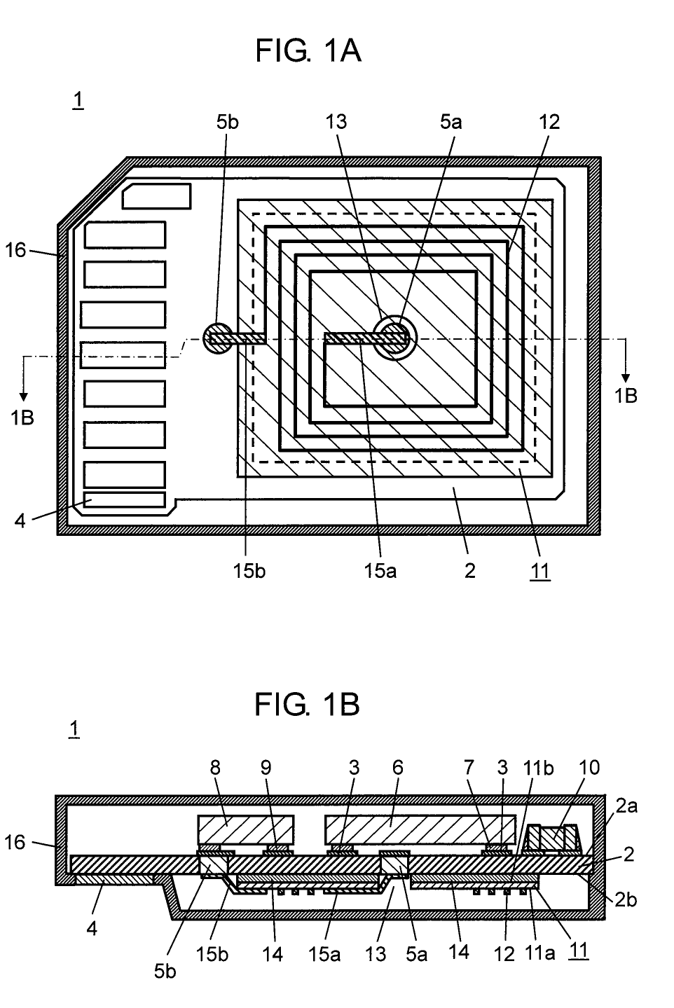

FIG. 1A and FIG. 1B are drawings for explaining an electronic circuit module with a built-in antenna in accordance with the exemplary embodiment of the present invention. FIG. 1A is a drawing of electronic circuit module with built-in antenna 1 as viewed from the backside thereof. In FIG. 1A, the bottom face of a case thereof is omitted so that the inside is visible. FIG. 1B is a sectional view taken on line 1B-1B of FIG. 1A.

As shown in FIG. 1A and FIG. 1B, electronic circuit module with built-in antenna 1 has a mounting module (not shown), resin sheet substrate 11, and magnetic layer 14 interposed therebetween that are built in case 16. The mounting module includes passive component 10, and electrodes 7 and 9 on semiconductor devices 6 and 8, respectively, which are mounted on the electrode terminals on wiring pattern 3 formed on first principle surface 2a of wiring board 2, and includes external connection terminal 4 provided on second principle surface 2b. In this exemplary embodiment, the example of semiconductor device 8 is a semiconductor device for control circuits, including a CPU. The example of semiconductor device 6 is a semiconductor memory device, such as a flash memory, FeRAM, MRAM, and RRAM. The example of passive component 10 is a capacitor, resistor, coil, or the like.

Resin sheet substrate 11 includes, on first principle surface 11a of the base thereof, antenna pattern 12 that has first terminal 15a and second terminal 15b. First terminal 15a of antenna pattern 12 projects in opening 13 through the base. Second terminal 15b projects from one side of the outer periphery of the base. Further, second principle surface 2b of wiring board 2 of the mounting module is bonded to second principle surface lib of the base of resin sheet substrate 11 via magnetic layer 14. These elements are housed in case 16 with at least external connection terminal 4 of wiring board 2 exposed. At this time, magnetic layer 14 is provided on second principle surface 11b of the base of resin sheet substrate 11 in a shape slightly larger than the outside dimension of antenna pattern 12 in the portion other than opening 13 through the base.

First terminal 15a and second terminal 15b of antenna pattern 12 are coupled to wiring pattern 3 by a conductive adhesive or the like, via penetrating electrodes 5a and 5b, respectively, which are provided through wiring board 2. The above coupling may be made by soldering as well as the conductive adhesive.

FIG. 1A and FIG. 1B show an example in which external connection terminal 4 is formed on second principle surface 2b of wiring board 2. However, the present invention is not limited to this structure. External connection terminal 4 is a terminal for transmitting and receiving data or supplying power in a contact manner. Thus, when data are transmitted and received or power is supplied via the antenna pattern in a non-contact manner, the external connection terminal is not necessarily required.

The materials usable for wiring board 2 are as follows: organic fibers, such as glass fiber and Kevlar, impregnated with epoxy resin, phenol resin, polyimide resin, or the like and cured; BT resin; liquid crystal polymer; and other various kinds of resin.

Usable for the base of resin sheet substrate 11 are various kinds of materials, such as polyester, and polyimide.

For magnetic layer 14, a magnetic sheet having a thickness in the range of 10 μm to 50 μm, for example, can be used. To form the magnetic sheet, a magnetic paste containing magnetic particles, e.g. ferrite powder, mixed in a resin, e.g. epoxy resin, is printed. With this structure, a magnetic layer having a thickness sufficient to absorb the required amount of electromagnetic waves can be formed. Thus, the antenna characteristics can be further improved. Alternatively, a magnetic ceramic sheet containing magnetic particles, e.g. ferrite, may be bonded. This ceramic sheet can provide a thinner structure that has greater advantage of shielding the incident of magnetic waves into the semiconductor devices.

Further, antenna pattern 12 is formed by attaching a Cu foil, for example, to the base of resin sheet substrate 11, and performing a photolithography process and an etching process thereon. This method can form finer antenna pattern 12 more easily than the method of printing the antenna pattern using a conductive paste. This method can satisfy the requirements of a longer antenna length for the 13.5-MHz band, for example.

The present invention can provide an electronic circuit module with a built-in antenna in which a magnetic layer shields the incident of electromagnetic waves into semiconductor devices in the mounting module thereof, and this shielding prevents the reflection of the electromagnetic waves from the semiconductor devices, and ensures transmission and reception at a stable antenna sensitivity and constant communication distance.

Hereinafter, a description is provided of a method of manufacturing an electronic circuit module with a built-in antenna in accordance with the exemplary embodiment of the present invention, with reference to the accompanying drawings.

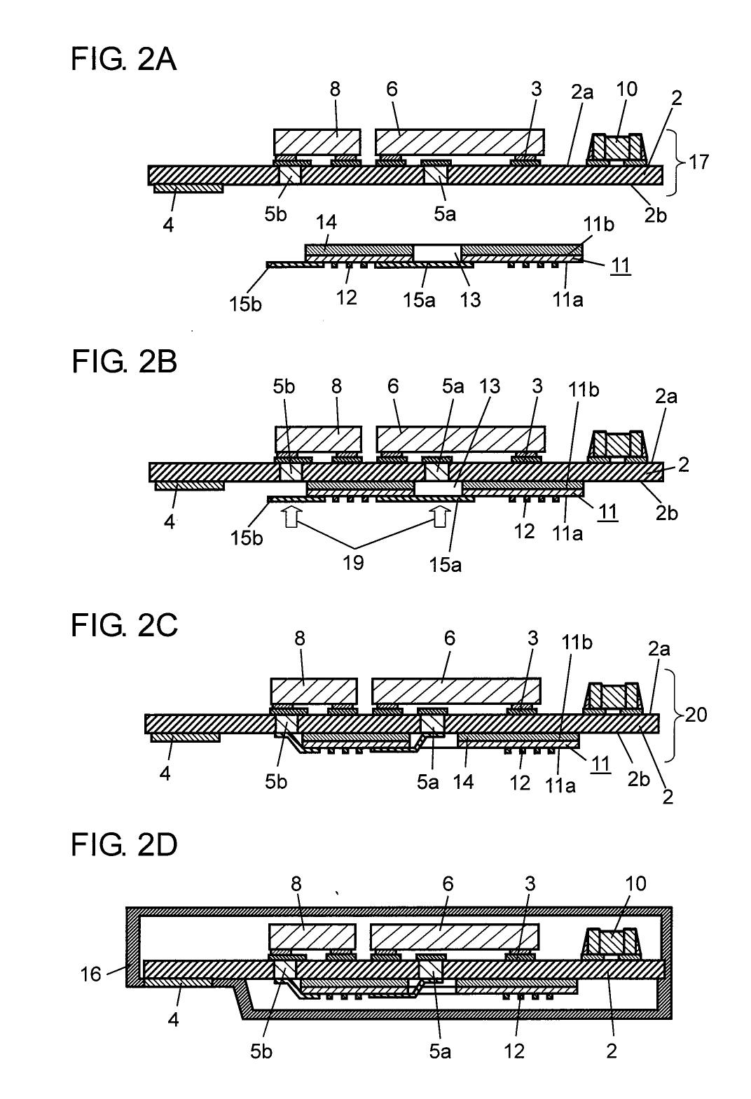

FIG. 2A through FIG. 2D are sectional views for explaining the method of manufacturing the electronic circuit module with the built-in antenna in accordance with the exemplary embodiment of the present invention.

First, as shown in FIG. 2A, through-holes are formed through wiring board 2, from first principle surface 2a to second principle surface 2b, by a molding, drilling, laser or other method. The through-holes are filled by plating or applying a conductive paste by printing so that penetrating electrodes 5a and 5b are formed. Then, wiring pattern 3 is formed on first principle surface 2a of wiring board 2, and external connection terminal 4 is formed on second principle surface 2b, by a photolithography method or the like. Further, semiconductor device 6, e.g. a semiconductor memory device, semiconductor device 8, e.g. a semiconductor device for control circuits, and passive component 10 are mounted on the electrode terminals provided in predetermined positions on wiring pattern 3, to form mounting module 17. At this time, electrodes 7 and 9, such as a solder bump, gold bump, and stud bump, are formed on semiconductor devices 6 and 8 in advance, and flip-tip mounted on the electrode terminals of wiring board 2.

After a Cu foil or the like is attached to first principle surface 11a of the base, antenna pattern 12 having first terminal 15a and second terminal 15b in a predetermined shape is formed by etching. Then, on second principle surface 11b of the base, magnetic layer 14 is formed by printing or the like. Thus, resin sheet substrate 11 is fabricated. At this time, opening 13 penetrating through first principle surface 11a and second principle surface 11b is formed through the base of resin sheet substrate 11. First terminal 15a of antenna pattern 12 projects in opening 13, and second terminal 15b thereof projects from one side of the outer periphery of resin sheet substrate 11.

Next, as shown in FIG. 2B, magnetic layer 14 formed on second principle surface 11b of the base of resin sheet substrate 11 is bonded to second principle surface 2b of wiring board 2 of mounting module 17, using an adhesive (not shown) or the like. At this time, first terminal 15a and second terminal 15b of antenna pattern 12 are aligned with penetrating electrode 5a and penetrating electrode 5b, respectively. In this state, pressure 19 is applied to first terminal 15a and second terminal 15b, using a bonding jig or the like, so that the terminals are bonded to penetrating electrodes 5a and 5b.

A metallic coating (not shown) made of Ni, Au, or the like may be provided on penetrating electrodes 5a and 5b by plating in advance to improve environmental resistance. Further, first terminal 15a and second terminal 15b may be connected to penetrating electrodes 5a and 5b by solder or conductive adhesive to improve the reliability, including connecting resistance and bonding strength.

The above steps provide integral structure 20 as shown in FIG. 2C in which mounting module 17 combine with resin sheet substrate 11.

Next, as shown in FIG. 2D, integral structure 20 is housed in case 16 with at least external connection terminal 4 thereof exposed. Thus, the electronic circuit module with the built-in antenna of the present invention is fabricated.

With reference to FIG. 2D, the descriptions are provided for an example in which external connection terminal 4 is formed on second principle surface 2b of wiring board 2 and the integral structure is housed in case 16 with external connection terminal 4 exposed. However, the present invention is not limited to this structure. For example, when the present invention is to be used in a non-contact manner, external connection terminal 4 need not be formed. This structure can improve the reliability, including dust resistance and moisture resistance.

Hereinafter, a detailed description is provided of a method of manufacturing a resin sheet substrate having an antenna pattern formed thereon that is used in the exemplary embodiment of the present invention.

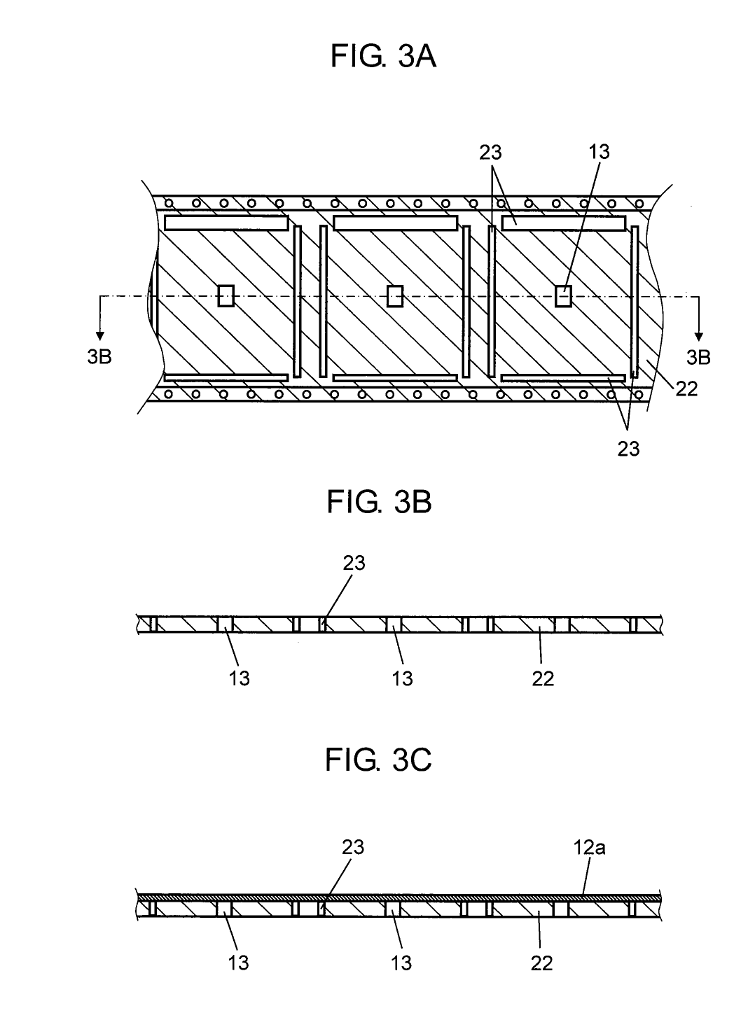

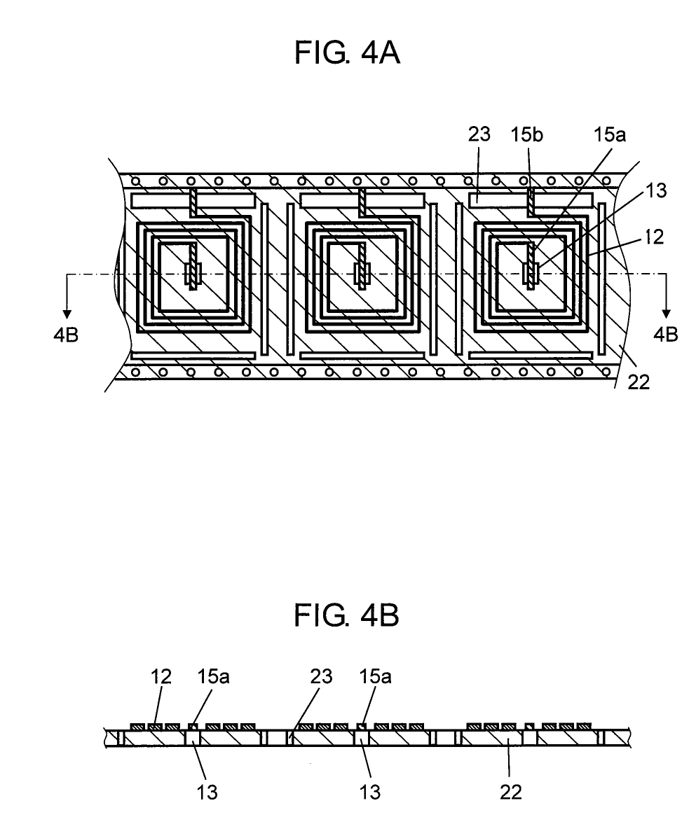

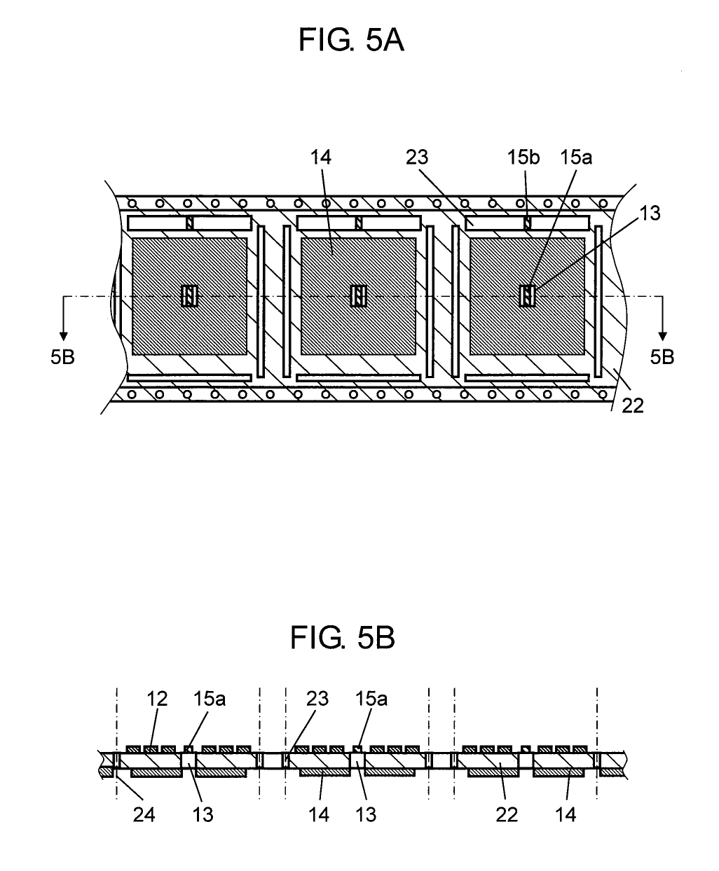

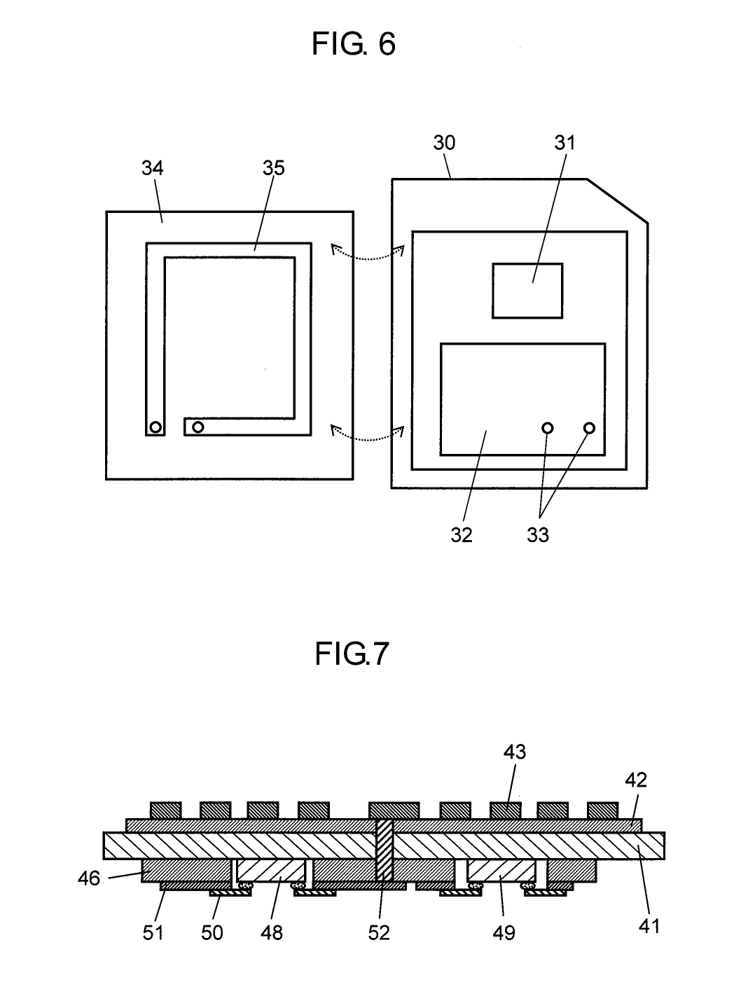

FIG. 3A through FIG. 5B are drawings for explaining a method of manufacturing a resin sheet substrate having an antenna pattern formed thereon that is used in the exemplary embodiment of the present invention. FIG. 3A is a drawing for explaining a first step of a method of manufacturing an antenna substrate. FIG. 3B is a sectional view taken on line 3B-3B of FIG. 3A. FIG. 3C is a sectional view for explaining the first step of the method of manufacturing the antenna substrate. FIG. 4A is a drawing for explaining a second step of the method of manufacturing the antenna substrate. FIG. 4B is a sectional view taken on line 4B-4B of FIG. 4A. FIG. 5A is a drawing for explaining a third step of the method of manufacturing the antenna substrate. FIG. 5B is a sectional view taken on line 5B-5B of FIG. 5A.

FIG. 3A and FIG. 3B show continuous carrier tape 22 having sprocket holes. In carrier tape 22, first openings 13, and second openings 23 forming the outer periphery of the mounting module in a rectangular configuration are formed in a ratio of first opening:second opening=1:4.

The above descriptions are provided for an example in which two openings are provided as second openings 23 between adjacent first openings 13. However, the two openings may be integrated into one opening.

Next, as shown in FIG. 3C, Cu foil 12a having a thickness of 30 μm, for example, is bonded to one face of carrier tape 22 to form antenna patterns.

Next, as shown in FIG. 4A and FIG. 4B, a photo-resist film is selectively formed on Cu foil 12 by a photolithography method, for example, and Cu foil 12a is etched. Thus, antenna patterns 12 are formed. At this time, first terminal 15a of antenna pattern 12 is formed to project in first opening 13, and second terminal 15b thereof is formed to project in second opening 23.

When the present invention is to be used in the 13.56-MHz band, antenna pattern 12 is formed to have a spiral shape in the area surrounded by second openings 23 as shown in FIG. 4A. However, the present invention is not limited to this antenna pattern. According to the band in which the present invention is to be used, various kinds of antenna patterns are formed.

Next, as shown in FIG. 5A, magnetic layer 14 is formed on carrier tape 22 on the side opposite the areas having antenna patterns 12 formed thereon, so as to cover at least the antenna patterns having a spiral shape. Thus, as shown in FIG. 5B, magnetic layer 14 is formed in the portions other than first openings 13 and second openings 23 to cover at least antenna patterns 12. At this time, magnetic layer 14 can be formed by applying a paste containing magnetic particles dispersed therein, or bonding a sheet containing magnetic particles dispersed therein, using an adhesive.

In the magnetic layer, the surfaces of the magnetic particles may be coated with insulating coatings. Such coating can further improve the insulating properties of resin sheet substrate 11.

Next, carrier tape 22 having antenna patterns 12 formed thereon is cut and divided into resin sheet substrate pieces along cutting plane lines 24 shown along second openings 23 of FIG. 5B. Thus, resin sheet substrate 11 is fabricated.

The manufacturing method of the present invention can provide the electronic circuit module with the built-in antenna at low cost and high productivity.

In this exemplary embodiment, the descriptions are provided for an example in which a carrier tape is cut and divided into resin sheet substrate pieces and the separate resin sheet substrate is fixed to a mounting module. However, the present invention is not limited to this method. For example, after the resin sheet substrate of the carrier tape is faced and fixed to the mounting modules, the carrier tape may be cut and divided into pieces so that the electronic circuit module with the built-in antenna each including the resin sheet substrate piece are provided. This method allows continuous production, thus providing electronic circuit modules with built-in antennas at lower cost and higher productivity.

### INDUSTRIAL APPLICABILITY

An electronic circuit module with a built-in antenna of the present invention is useful for a semiconductor memory device, e.g. an SD memory card, and an electronic device for a wireless LAN that are requested to have a smaller thickness, higher density, and higher reliability.

1. An electronic circuit module with a built-in antenna, comprising:
a mounting module, the mounting module including:
a wiring board that has a wiring pattern formed on a first principle surface thereof and coupled to a passive component and a semiconductor device, and a plurality of penetrating electrodes coupled to the wiring pattern; and
the passive component and the semiconductor device mounted on the wiring board;
a resin sheet substrate that has an antenna pattern formed on a first principle surface of a base thereof so that a first terminal of the antenna pattern projects in an opening provided through the base and a second terminal of the antenna pattern projects from one side of an outer periphery of the base; and
a magnetic layer interposed between a second principle surface of the wiring board of the mounting module and a second principle surface of the base of the resin sheet substrate,
wherein, the semiconductor device is electrically coupled to the first terminal and the second terminal of the resin sheet substrate via the penetrating electrodes of the mounting module, and the mounting module and the resin sheet substrate are housed in a case.

2. The electronic circuit module with the built-in antenna of claim 1, wherein the magnetic layer is formed on the second principle surface, which is a side opposite to the surface having the antenna pattern formed thereon, of the resin sheet substrate.

3. The electronic circuit module with the built-in antenna of claim 1, wherein the magnetic layer is formed of a magnetic ceramic sheet made of ferrite, or a magnetic sheet made of a resin containing a magnetic particle.

4. The electronic circuit module with the built-in antenna of claim 1, wherein the semiconductor device includes a semiconductor memory device and a semiconductor device for a control circuit.

5. The electronic circuit module with the built-in antenna of claim 1, wherein the wiring board has an external connection terminal coupled to the wiring pattern, and the external connection terminal is exposed from the case.

6. A method of manufacturing an electronic circuit module with a built-in antenna, comprising:
mounting a passive component and a semiconductor device on a wiring board that has a wiring pattern formed on a first principle surface thereof and to be coupled to the passive component and the semiconductor device, and a plurality of penetrating electrodes coupled to the wiring pattern, thereby forming a mounting module;
forming an antenna pattern on a first principle surface of a base of a resin sheet substrate so that a first terminal of the antenna pattern projects in an opening provided through the base and a second terminal of the antenna pattern projects from one side of an outer periphery of the base;
bonding a second principle surface of the base of the resin sheet substrate to a second principle surface of the wiring board via a magnetic layer, and coupling the first terminal and the second terminal of the antenna pattern to the penetrating electrodes of the mounting module; and
housing the mounting module and the resin sheet substrate in a case.

7. The manufacturing method of claim 6, further comprising successively forming the antenna patterns on a carrier tape, and cutting and dividing the carrier tape into pieces of the resin sheet substrate having the separate antenna pattern thereon before the bonding and the coupling.
